(19) United States
(12) Patent Application Publication
(10) Pub. No.: US 2008/0142692 A1
(43) Pub. Date: Jun. 19, 2008

(54) Intelligent tripwire system

(76) Inventor: Lanny R. Lee, Toms River, NJ (US)

Correspondence Address: Lanny R. Lee, STE. 324, 1358 HOOPER AVE., Toms River, NJ, 08753, US

(21) Appl. No.: 11/640,762

(22) Filed: Dec. 18, 2006

(51) Int. Cl. G01J 1/04

(52) U.S. Cl. 250/227.14

(57) ABSTRACT

This device is a system actuated when a loop of fiber optic strand is exposed in a pathway characterized of a tripwire device.

A basic system having a light source emits light through a fiber optic conductor to a light detector that converts the receiving status to an electrical signal. In event of a break event of the fiber optic the detector sends electrical energy to an actuator whereby a device is activated. The activated device could be, but not limited to, launched ordinance, video surveillance, alarm sound and complex systems can report speed and direction of objects. Furthermore systems are capable of determine the identification of the object causing the break event and stand the system down to reserve system assets. These systems cam be arranged as slave systems to a central processor. An important feature is that a system is that it can be programmed to time out to safely be repositioned and serviced.

### FIELD OF THE INVENTION

This invention relates to devices that might be referred to generically as “tripwire” activated.

### BACKGROUND AND PRIOR ART

A tripwire is a term generically used to describe a device having a wire stretched tightly across a road or pathway that an unaware passerby or vehicle interferes with the wire connected to the trigger of a device. Several disadvantages of this type of triggering mechanism is that it on order to be sensitive enough to react to slight pulls at the tripwire it is difficult to conceal and is prone to fowling by weather and corrosion and also once set, it is risky to handle without accidentally triggering. Information of tripwire systems is scant and likewise little is available in the patent office regarding modern discrete ordinance and data acquisition. The best information on the information is extrapolated using what is published in the U.S. Patent Office. Using logic as the Fermi Principle we are able to learn much by searching our methods of detection and sweeping. Unfortunately, there is next to nothing available about marine placement and sweeping. For obvious reasons researching beyond the public library is not recommended.

### DESCRIPTION OF THE PREFERRED EMBODIMENTS

Before explaining the disclosed embodiments of the present invention it is to be understood that the invention is not limited to the particular arrangements shown since the invention is capable of other embodiments. Also, the terminology used herein is for the purpose of description and not of limitation.

The conduit referred to in the description is commonly known as fiber optic strands and are drawn from, very pure, molten silicon. Having very small diameters, approximately the thickness of a human hair these strands or fibers take the impression of being quite flexible and that being because mostly the bend radius is proportionately large compared the diameter of the strand. A strand is like most glass and very brittle in bending and shear, however, these strands do quite well in tension and compression.

If one if these strands was lying on a concrete floor then stepped on by a person wearing shoes the strand would suffer multiple breaks. Handling of fiber optical safely requires training and special equipment.

The invention is not responsible for the application or the use thereof.

My invention is a tripwire of conduit known as a fiber optic strand; smaller in diameter than a human hair or less than 100 microns. These strands sustain cohesive columns of light beamed great distances bouncing along within the walls and unaffected by gentle curves and bends in the conduit; however, abrupt bends and shocks will cause the light to drop out of the conduit. Usually the passage is restored when the bend is sufficiently relaxed. This momentary loss of light passage can be logged in a time domain. This provides an event record that will provide data will provide information to determine the nature of the disruption. Since the loop is not broken the distance from the light that the event occurred cannot be determined. When a separation of the strand causes the light beam to return, or in other words is bounced back to its source. Therefore, as the speed of light is constant the time it takes for the emitted light to return is the length of the fiber optic stand. These fibers being long brittle silicon crystals and as with glass will not break partially.

This is a partial listing of ways the fiber optic conduit is deployed in various modes; (a) suspending it between two supports in the air, (b) presented to be picked up in an air stream my propellers (c) laying it across and or below the ground and a combination, (d) suspended through a body of water between supports (e) another marine deployment connected between a device and buoyed (f) tethered from an end and towed behind a vessel.

Although the device and system might be located some distance from the active portion of the fiber optic, it could be camouflaged to blend with features of the surrounding. The fiber optic conduit may be coated with adhesive that prevents countermeasures or wind from blowing it from a surface; however, brushing of sweeping would likely break the fiber. In special applications the conduit may have features such as nodules to cause the fiber more easily broken as would be if cushioned by snow, mud or sand.

We can learn from the loss of light from the conduit that an object is disturbing the fiber and it is an intermittent loss that it being bounced by air turbulence and likewise in water by contact with a hull of a vessel. This might be confirmed by a regain of passage followed by a break caused by the propeller. It is unlikely that marine life would supply more than an occasional bump and not a break. Fisher nets would likely cause a long period of loss of light followed by a break of the conduit.

Arrayed deployment and observation can usually confirm when sweeping methods are involved. Considering the deployment in the air being suspended across a pathway and snagged by the antenna of a vehicle there would likely be a long period of a loss of light followed be a return of light to source when a break occurs and then providing information to give a distance to the break point. Another air method is when conduit is presented it such a way to be picked up an air stream such as with rotors whereby there would be a great amount of agitation resulting in an intermittent loss of light in some instances, when followed by a break proving a definite signature of events. Countermeasures here are unlikely. Ground deployment supplies it's own set of signatures; a sharp break following a brief loss of light would mean either a fast moving vehicle possibly with a countermeasure device to break the fiber. Either case the asset of the system would be reserve to be reset. The system would, if required, have a time out feature that would permit service and repositioning when desired.

This system is practically impossible to detect because decoy and active fibers are very cheap and easily deployed; often on as little as a favorable breeze. The active device is easily concealed in a location a distance from the pathway being monitored by this system and lofted from sight and over terrain and structures. The capability of measuring to the point of break permits fractional thrust launching from a shallow trajectory to the point of break.

When the target object is moving too fast or it is determined to be a countermeasure will stand down remaining and likely remain concealed awaiting a time out period to safely replace the conduit. This is to conserve the assets while remaining concealed. A system maybe further enhanced with an override allowing an operator to manually actuate end likewise de activate a system. As in the application with ordinance components, usually located a distance from the launch site of a system, are recoverable and can be moved to another location to reloaded and reset. The control package excluding the device or ordinance may be held in one hand. Therefore, the asset value of system is not a major consideration.

Basic input provides the processor with information to conserve the assets while the remaining fiber can remain active. The signature of the bending immediately prior the break event will supply by the processor information as to the identity of the object breaking the conduit.

A conduit is deployed or replaced with little possibility of being detected or if desired mimicked being deployed causing the target to divert into an active conduit. This means that a conduit is placed after a countermeasure or robotic is past. Often an override controller is present to hold the system to so as to cause a system to ignore a break event and reactivate and monitor any difference in length of remaining conduit. This system will keep opposing forces in a state of high anxiety anticipating a move and while they move. A major importance of the system is that the interloper remains unaware that a system has become activated.

### DESCRIPTION OF THE DRAWINGS

FIG. 1 teaches us using a chart the basic light table plotting a light cycle: the light completes the cycle from it's origin to the detector that feeds back the arrival of arrival information.

FIG. 1a demonstrates a chart of an interrupted light path where the bending limits of the conduit is exceeded or by vibration. The light column path is may be restored when conduit is relaxed.

FIG. 1b shows the column of light lost momentarily before the fiber is broken whereby the light is returned to the origin.

FIG. 1c shows the plot of a bounced column of light returned to the source.

FIG. 1d shows an altered rebounding light beam

FIG. 1e shows an altered rebounding light beam

FIG. 1d shows an altered rebounding light beam

FIG. 2 shows a schematic of a basic system

FIG. 3 shows a schematic of a system with controls

FIG. 4 shows a schematic of a slave system

FIG. 5 is a schematic of an arrayed deployment

FIG. 6 shows a plot providing speed and angle

FIG. 7 shows a bead

FIG. 7a is another view of bead

FIG. 8 shows a bead causing a shear

FIG. 9 shows a covered conduit

FIG. 9a is another view of a covered conduit

FIG. 10 shows a concealed launcher

FIG. 10a shows two types of trajectories

FIG. 11 represents a marine vessel breaking conduit

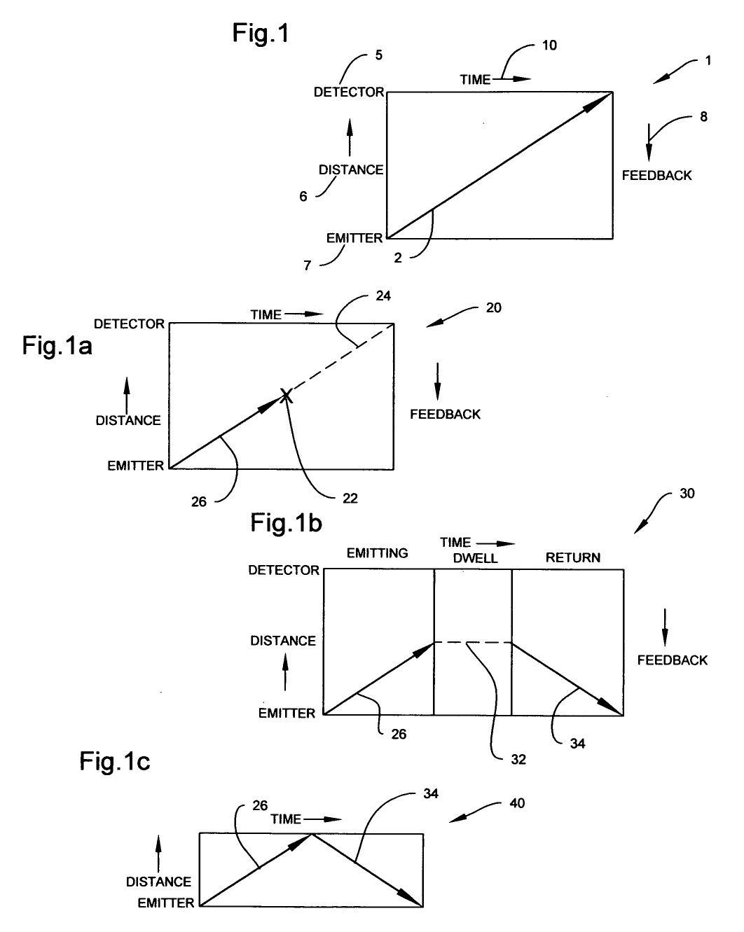

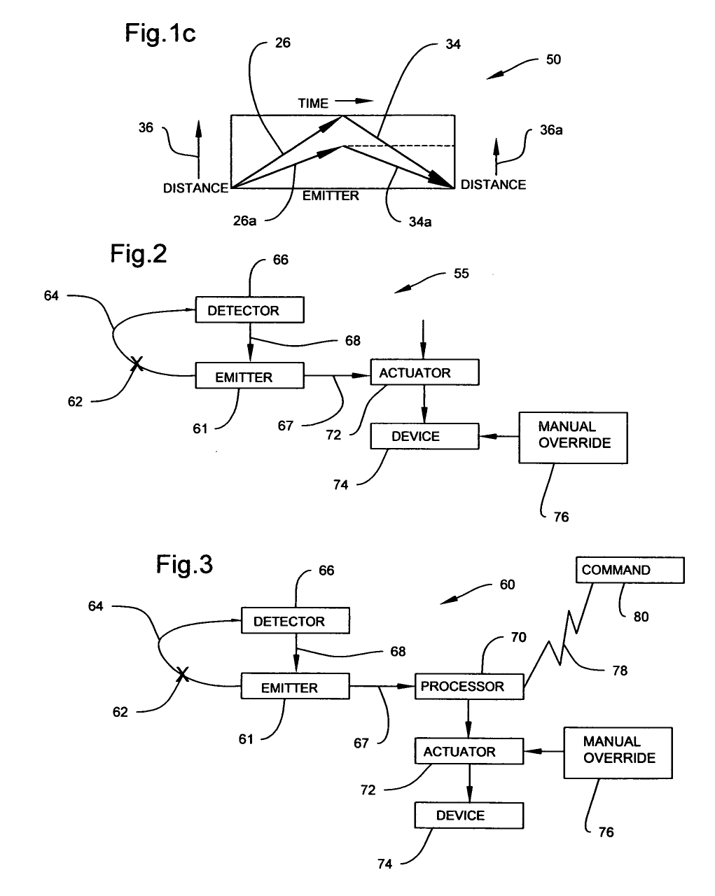

FIG. 1 is a chart showing a plot 1 showing distance 2 obtained by plotting speed 6 from a light source 7 traveling to a detector 5 verse time 10 with data of the event feedback 8 proving a light and information loop. FIG. 1a is a plot 20 the event shown while the light is lost at 22 resulting an unknown distance 26. No light reaches the detector 5 therefore broken a line represents lost light path 24. FIG. 1b is a plot 30 showing a distance 28 providing data to help identify the breaking means followed by period of lost light 32 having and then a distance of light 34. FIG. 1c is a plot 40 of that distance 28 to break point 44 returned equal distance 34 provides the data to measure the distance to break 44. FIG. 50 is a plot 50 showing a distance 26 to break point 44 returned a distance 34 then a shorter distance 26d to point 46 returned equal distance 34a proving information to determine a new shorter distance to a break.

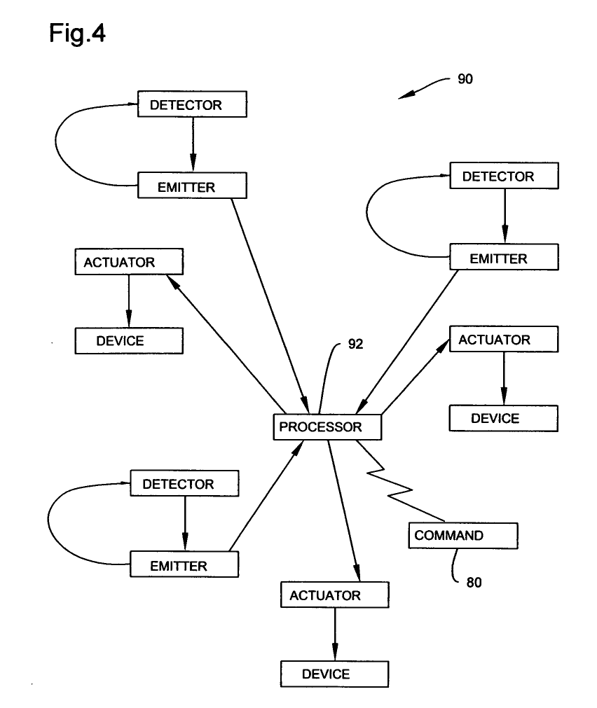

FIG. 2 shows one possible schematic of a system 60 having a combination light source and detector 61 through conduit 64 to detector 66 in break 62 event data is sent to actuator 72 activating a device. Override controller 76 is a provided option. FIG. 3 shows one possible schematic of a system 60 having a combination light source and detector 61 through conduit 64 to detector 66 with feedback 68 to combination light source and detector 61 data with data sent to processor 70 and optional data link 78 to command 80. In break 62 event data is sent to processor to be analyzed by processor 70 and if criteria are met a signal is sent to actuator activating a device. Override controller 78 also is a provided option. FIG. 4 is one example of a more complex system having a processor 92 providing control to a plural array of devices and a optional data link to a command 80.

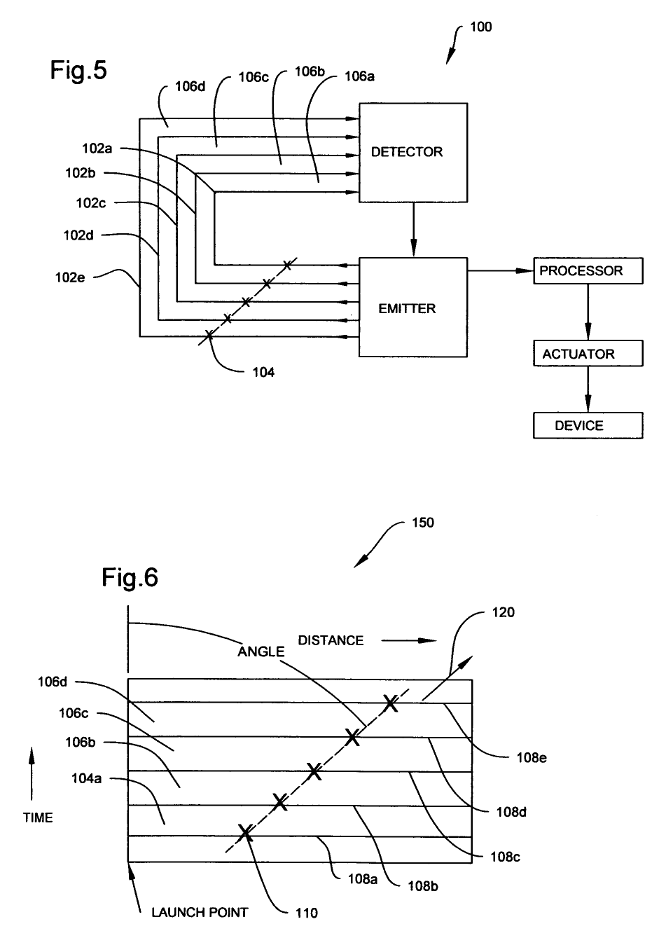

FIG. 5 is an example of a variety of arrayed conduit 102a, 102b, 102c and also 102d each having interval 106a, 106b, 106c, 106d including 106e conduit is broken 104 along path 107. FIG. 6 is a plot 150 showing data of the break events with the chart horizontal lines 108a, 108b, 108c, 108d and 108e representing respective conduit while respective intervals 109a, 109b, 109c, and 109d represented. Breaks 110 are plotted giving a plot 115 and speed 120 with angle of path 125.

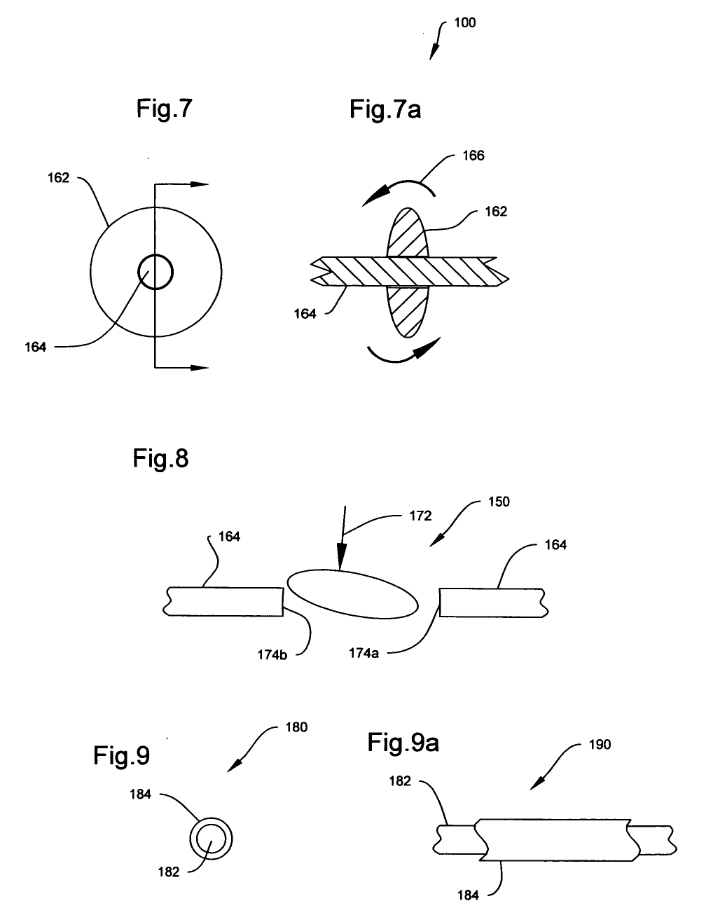

FIG. 7 represents bead arrangement 160 to lower shear force showing the longitudinal view FIG. 7a of a bead 162 plural placed approximately coaxial with conduit 164. A sectional representation in FIG. 6a is showing rotation 166 providing shear of conduit 164. FIG. 8 shows a force vector 172 rotating bead 162 to shear conduit 164 at 174a and 174b.

FIG. 8 a longitudinal view of conduit 180 with conduit 182 being covered 184. FIG. 8a is a section view of conduit 182 showing covering 184. Covering 184 depending on the application may be a light shield, reinforcing, adhesive or other substance.

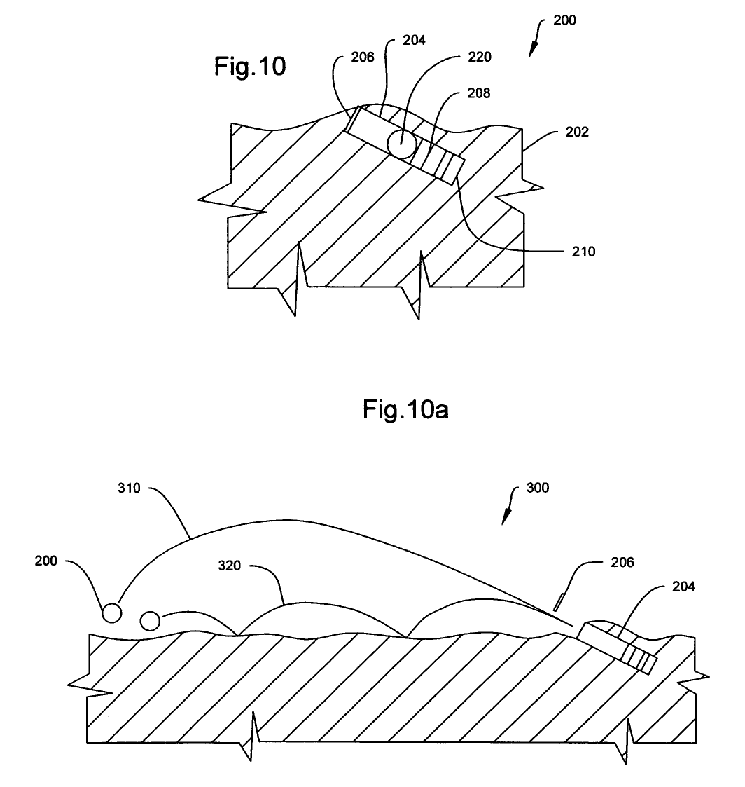

FIG. 10 A concealed deployment 200 is shown; however concealment is not a requirement for deployment. A cover to launcher 204 housing projectile 220 ahead of propellant 108 packages and actuator 210 in soil 202. FIG. 10a shows a launch 300 with projectile 220 having trajectory 310 being a lofted path while trajectory 310 using less propellant 108 packages is a low glancing path 320.

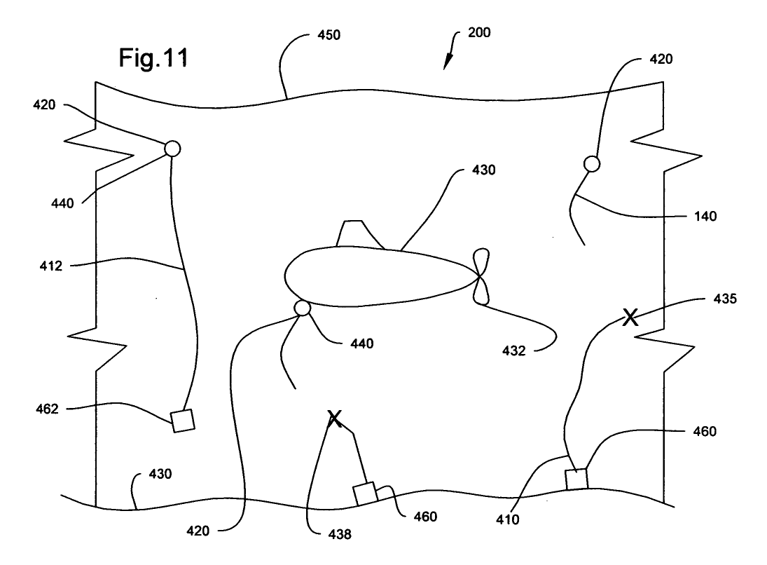

FIG. 11 is a view of a marine vessel 430 having caused break 435 by of feature 432 of vessel 430 of a conduit 410 that was tethered by buoy 420 and is approaching a conduit 412 also suspended from similar buoy 420 having magnet 440. Buoy 420 having magnetic feature is seen attracted to body of vessel 430 with an attracting force sufficient to break conduit 420 at 438. Water surface 450 and floor 430 are shown for reference. Device 460 is seen on bottom while device 462 is seen floating.

We claim:

1. I claim a tripwire system deployed on, or below, or suspended to pathway on land or air or marine comprising;
A fiber optic conduit having a first end having a light source commuting by light to a light detector having capability of converting light to electrical signal provided at a second end whereby if the fiber optic conduit is broken along the length whereby light passage is lost detector communicates with the actuator thereby activating a device.

2. The tripwire device according to claim 1 wherein conduit is fiber optic fiber.

3. The tripwire device according to claim 1 wherein light source is a laser.

4. The tripwire device according to claim 1 wherein that device is a camera.

5. The tripwire device according to claim 1 wherein device is an audio device.

6. The tripwire device according to claim 1 wherein device is explosive ordinance.

7. The tripwire device according to claim 1 wherein devices is explosive ordinance launched from canister.

8. The tripwire device according to claim 1 wherein that device telecommutes to a command station.

9. The tripwire device according to claim 1 wherein that tripwire is fiber optic fiber is made frangible by arrayed modules,

10. The tripwire device according to claim 1 wherein that tripwire is fiber optic fiber is coated with adhesive.

11. The tripwire device according to claim 1 wherein the system has a time out of service period.

12. The tripwire device according to claim 1 wherein that tripwire is fiber optic fiber is coated with adhesive.

13. I Claim A tripwire system deployed on, or below, or suspended to pathway on land or air or marine comprising;
Plural fiber optic conduit having a first end having a common combination light source with first light detector feature capable of converting light to electrical signal commuting through fiber optic conduit to a second light detector also having capability of converting light to electrical signal provided at a second end whereby if the fiber optic conduit is disrupted or disrupted then broken along the length by an event whereby light passage is intermittent or lost the first and second light detectors communicates with a computer having software capability to analyze the event and if conditions are met the computer communicates to the actuator thereby activating a device.

14. The tripwire device according to claim 13 wherein when plural is fiber optic fiber are arrayed,

15. The tripwire device according to claim 13 wherein processor is a computer,

16. The tripwire device according to claim 13 wherein devices is explosive ordinance having a partial thrust launched from canister,

17. The tripwire device according to claim 13 wherein that criterion is computer software,

18. The tripwire device according to claim 13 wherein that device telecommutes to a command station.

19. I Claim a tripwire system deployed on, or below, or suspended to pathway on land or air or marine comprising;
Plural fiber optic conduit having a first end having a combination light source with first light detector feature capable of converting light to electrical signal commuting through fiber optic conduit to a second light detector also having capability of converting light to electrical signal provided at a second end whereby if the fiber optic conduit is disrupted or disrupted then broken along the length by an event whereby light passage is intermittent or lost the first and second light detectors communicating with a common computer having software capability to analyze the event and compute speed and direction of object whereby when conditions are met the computer communicates to the actuator thereby activating a device.
